(19) United States
(12) Patent Application Publication
(10) Pub. No.: US 2008/0304116 A1
(43) Pub. Date: Dec. 11, 2008

(54) SHEET-FEEDING SCANNER

(75) Inventor: Hsin-Wen Lee, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 11/949,575

(22) Filed: Dec. 3, 2007

(30) Foreign Application Priority Data
Jun. 8, 2007 (TW) 096120660

(51) Int. Cl. H04N 1/04

(52) U.S. Cl. 358/498

(57) ABSTRACT

The present invention relates to a sheet-feeding scanner including an automatic document feeder and an image scanning portion. The automatic document feeder includes a U-shaped transfer path, a first scanning window and a first scanning module. The U-shaped transfer path includes a sheet pick-up section, a sheet reverse region and a scan region. The first scanning window in disposed in the sheet reverse region. The first scanning module is arranged beside the first scanning window for scanning the image of a first side of the paper sheet. The image scanning portion is disposed under the automatic paper feeder, and includes a second scanning window and a second scanning module. The second scanning window is disposed in the scan region. The second scanning module is arranged under the second scanning window for scanning the image of a second side of the paper sheet.

### FIELD OF THE INVENTION

The present invention relates to a sheet-feeding scanner, and more particularly to a sheet-feeding scanner for performing a duplex scanning operation.

### BACKGROUND OF THE INVENTION

The commercial available image scanners are generally classified into two major types, i.e. flatbed scanners and sheet-feeding scanners. For a purpose of successively scanning many paper sheets at a time, an automatic paper feeder (ADF) is usually integrated into the sheet-feeding scanner. After a stack of paper sheets to be scanned are placed on the sheet input tray of the automatic document feeder, the sheet-feeding mechanism of the automatic document feeder will successively transport the paper sheets across the scanning module of the sheet-feeding scanner to perform the scanning operation. This means of automatically feeding the paper sheets is both time-saving and efficient.

Recently, a sheet-feeding scanner has been developed for simultaneously or successively scanning images on both sides of a document during the document is transported through the scanning module of the sheet-feeding scanner. Referring to FIG. 1, a schematic cross-sectional view of a conventional sheet-feeding scanner having two scanning modules for performing a duplex scanning operation is illustrated. The sheet-feeding scanner 1 of FIG. 1 principally includes an automatic paper feeder 11 and an image scanning portion 12. The automatic document feeder 11 comprises a sheet pick-up module 111, a scanning window 112, a scanning module 113 and a U-shaped transfer path 114. The U-shaped transfer path 114 includes a sheet pick-up section 114A, a sheet reverse region 114B and a scan region 114C. The sheet pick-up module 111 is disposed in the sheet pick-up section 114A for successively feeding the paper sheet S into the automatic document feeder 11. The scanning window 112 is a transparent window and disposed in the scan region 114C. The scanning module 113 is disposed in the scan region 114C and arranged above the scanning window 112 for scanning the image of a first side S1 of the paper sheet S. In addition, the scanning module 113 includes a light source 113A, a reflective mirror set 113B, a lens set 113C and a charge coupled device (CCD) 113D.

Please refer to FIG. 1 again. The image scanning portion 12 is disposed under the automatic paper feeder 11. The image scanning portion 12 includes a scanning window 121 and a scanning module 122. The scanning window 121 is a transparent window and disposed in the scan region 114C. The scanning module 122 is also disposed in the scan region 114C for performing either a flatbed scanning operation or a sheet-feeding scanning operation on the paper sheet S. During the sheet-feeding scanning operation of the image scanning portion 12, the scanning module 122 is moved under the scanning window 121 for scanning the image of a second side S2 of the paper sheet S. In addition, the scanning module 122 includes a light source 122A, a reflective mirror set 122B, a lens set 122C and a charge coupled device (CCD) 122D.

Please refer to FIG. 1 again. Since the scanning modules 113 and 122 are both arranged in the scan region 114C, the light beams emitted from the light sources 113A and 122A are readily interfered with each other. As a consequence, a so-called image overlay effect or shading effect is generated to impair the scanning quality of the sheet-feeding scanner 1. For example, when the light beam emitted from the light source 122A of the scanning module 122 is projected on the second side S2 of the paper sheet S, a majority of the light beam is reflected from the second side S2 but a minority of the light beam penetrates through the paper sheet S. If the first side S1 of the paper sheet S is being scanned by the scanning module 113, the penetrative light of the light source 122A will also be received by the scanning modules 113. Since the images of the first side S1 and the second side S2 of the paper sheet S are simultaneously scanned by the scanning module 113, the shading effect occurs.

In views of the above-described disadvantages resulted from the prior art, the applicant keeps on carving unflaggingly to develop an improved sheet-feeding scanner according to the present invention through wholehearted experience and research.

### SUMMARY OF THE INVENTION

It is an object of the present invention to provide a sheet-feeding scanner having two scanning modules for performing a duplex scanning operation, in which these scanning modules are separately arranged to avoid interference of the light beams emitted from these scanning modules and minimize the shading effect.

In accordance with an aspect of the present invention, there is provided a sheet-feeding scanner for scanning a first side and a second side of a paper sheet. The sheet-feeding scanner includes an automatic document feeder and an image scanning portion. The automatic document feeder includes a U-shaped transfer path, a first scanning window and a first scanning module. The U-shaped transfer path includes a sheet pick-up section, a sheet reverse region and a scan region. The first scanning window in disposed in the sheet reverse region. The first scanning module is arranged beside the first scanning window for scanning the image of the first side of the paper sheet. The image scanning portion is disposed under the automatic paper feeder, and includes a second scanning window and a second scanning module. The second scanning window is disposed in the scan region. The second scanning module is arranged under the second scanning window for scanning the image of the second side of the paper sheet.

In an embodiment, a sheet-pressing roller is further arranged in the sheet reverse region for pressing the paper sheet such that the paper sheet is in contact with the first scanning window.

In an embodiment, a sheet-pressing slice is further arranged in the sheet reverse region for pressing the paper sheet such that the paper sheet is in contact with the first scanning window.

In an embodiment, the sheet-feeding scanner further includes at least one intermediate roller assembly in the sheet reverse region.

In an embodiment, the first scanning window includes a light source, a reflective mirror set, a lens set and a charge coupled device.

In an embodiment, the second scanning window includes a light source, a reflective mirror set, a lens set and a charge coupled device.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view of a conventional sheet-feeding scanner having two scanning modules for performing a duplex scanning operation;

FIG. 2 is a schematic cross-sectional view of a sheet-feeding scanner having two scanning modules for performing a duplex scanning operation according to a first preferred embodiment of the present invention;

FIG. 3A is a schematic partial enlarged view of the sheet-feeding scanner having a sheet-pressing roller according to the first preferred embodiment of the present invention; and

FIG. 3B is a schematic partial enlarged view of another sheet-feeding scanner with a sheet-pressing slice according to a second preferred embodiment of the present invention.

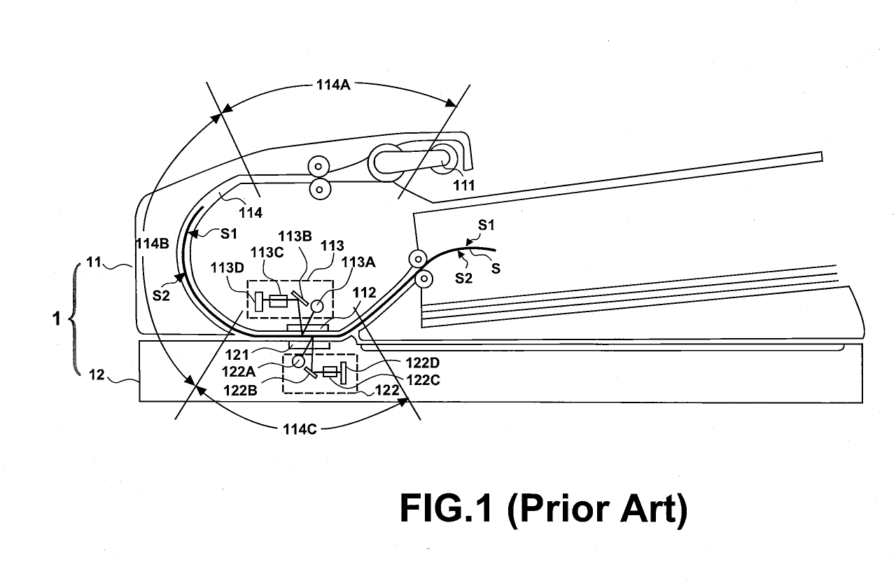

### DETAILED DESCRIPTION OF THE PREFERRED EMBODIMENT

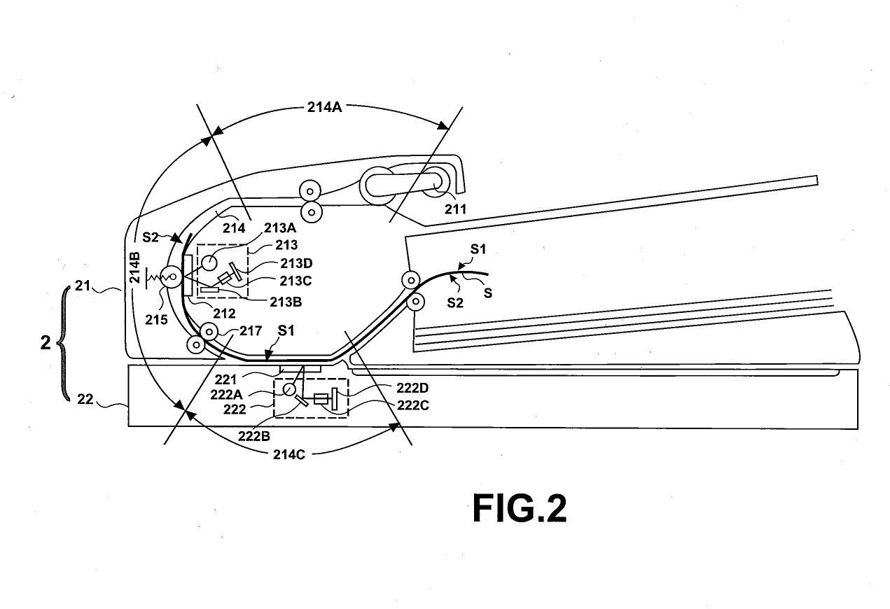

Referring to FIG. 2, a schematic cross-sectional view of a sheet-feeding scanner having two scanning modules for performing a duplex scanning operation according to a first preferred embodiment of the present invention is illustrated. The sheet-feeding scanner 2 of FIG. 2 principally includes an automatic paper feeder 21 and an image scanning portion 22. The automatic document feeder 21 comprises a sheet pick-up module 211, a scanning window 212, a scanning module 213 and a U-shaped transfer path 214. The U-shaped transfer path 214 is a passageway of transferring a paper sheet S therethrough. The U-shaped transfer path 214 includes a sheet pick-up section 214A, a sheet reverse region 214B and a scan region 214C. The sheet pick-up module 211 is disposed in the sheet pick-up section 214A for successively feeding the paper sheet S into the automatic document feeder 21. The scanning window 212 is a transparent window and disposed in the sheet reverse region 214B. The scanning module 213 is disposed in the sheet reverse region 214B and arranged beside the scanning window 212 for scanning the image of a first side S1 of the paper sheet S. In addition, the scanning module 213 includes a light source 213A, a reflective mirror set 213B, a lens set 213C and a charge coupled device (CCD) 213D.

Please refer to FIG. 2 again. The image scanning portion 22 is disposed under the automatic paper feeder 21. The image scanning portion 22 includes a scanning window 221 and a scanning module 222. The scanning window 221 is a transparent window and disposed in the scan region 214C. The scanning module 222 is disposed in the scan region 214C for performing either a flatbed scanning operation or a sheet-feeding scanning operation on the paper sheet S. During the sheet-feeding scanning operation of the image scanning portion 22, the scanning module 222 is moved under the scanning window 221 for scanning the image of a second side S2 of the paper sheet S. In addition, the scanning module 222 includes a light source 222A, a reflective mirror set 222B, a lens set 222C and a charge coupled device (CCD) 222D.

In the above embodiment of FIG. 2, the sheet-feeding scanner 2 has the scanning module 222 in the image scanning portion 22 and the additional scanning module 213 in the sheet reverse region 214B of the U-shaped transfer path 214. Consequently, when the paper sheet S is transported across the U-shaped transfer path 214, the images of the first side S1 and the second side S2 of the paper sheet S are successively scanned by the scanning module 213 and the scanning module 222, respectively, so as to implement the duplex scanning operation. Since the scanning module 213 and the scanning module 222 are separately arranged, the interference of the light beams emitted from the light sources 213A and 222A are minimized and thus the shading effect is avoided.

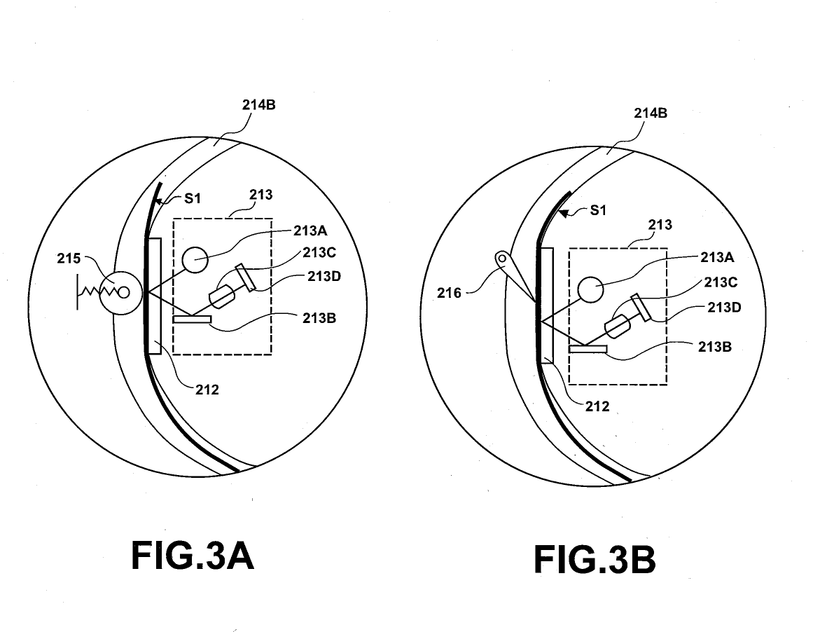

FIG. 3A is a schematic partial enlarged view of the sheet-feeding scanner 2. As shown in FIG. 3A, the scanning module 213 is disposed in the sheet reverse region 214B of the U-shaped transfer path 214. Moreover, a sheet-pressing roller 215 is arranged in the sheet reverse region 214B. Since the paper sheet S passing through the sheet reverse region 214B is pressed by the sheet-pressing roller 215, the paper sheet S may lie flat on the scanning window 212. Under this circumstance, the focus value of the paper sheet S is kept within the depth-of-field range of the scanning module 213 to prevent defocus aberration.

In the embodiment of FIG. 3A, the sheet-pressing roller 215 is disposed in the sheet reverse region 214B for allowing the paper sheet S to be in contact with the scanning window 212. It is noted that, however, those skilled in the art will readily observe that numerous modifications and alterations may be made while retaining the teachings of the invention. For example, as shown in FIG. 3B, a sheet-pressing slice 216 is arranged in the sheet reverse region 214B for allowing the paper sheet S to be in contact with the scanning window 212.

Please refer to FIG. 2 again. The automatic document feeder 21 of the sheet-feeding scanner 2 has at least one intermediate roller assembly 217 in the sheet reverse region 214B of the U-shaped transfer path 214. After the paper sheet S is fed into the U-shaped transfer path 214 by the sheet pick-up module 211, the intermediate roller assembly 217 may facilitate transferring the paper sheet S across the scanning modules 213 and 222 to perform a duplex scanning operation on the paper sheet S.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A sheet-feeding scanner for scanning a first side and a second side of a paper sheet, said sheet-feeding scanner comprising:
an automatic document feeder including a U-shaped transfer path, a first scanning window and a first scanning module, wherein said U-shaped transfer path includes a sheet pick-up section, a sheet reverse region and a scan region, said first scanning window in disposed in said sheet reverse region, and said first scanning module is arranged beside said first scanning window for scanning the image of said first side of said paper sheet; and
an image scanning portion disposed under said automatic paper feeder, and including a second scanning window and a second scanning module, wherein said second scanning window is disposed in said scan region, and said second scanning module is arranged under said second scanning window for scanning the image of said second side of said paper sheet.

2. The sheet-feeding scanner according to claim 1 wherein a sheet-pressing roller is further arranged in said sheet reverse region for pressing said paper sheet such that said paper sheet is in contact with said first scanning window.

3. The sheet-feeding scanner according to claim 1 wherein a sheet-pressing slice is further arranged in said sheet reverse region for pressing said paper sheet such that said paper sheet is in contact with said first scanning window.

4. The sheet-feeding scanner according to claim 1 further including at least one intermediate roller assembly in said sheet reverse region.

5. The sheet-feeding scanner according to claim 1 wherein said first scanning window includes a light source, a reflective mirror set, a lens set and a charge coupled device.

6. The sheet-feeding scanner according to claim 1 wherein said second scanning window includes a light source, a reflective mirror set, a lens set and a charge coupled device.
